(19) United States
(12) Patent Application Publication
(10) Pub. No.: US 2024/0270959 A1
(43) Pub. Date: Aug. 15, 2024

(54) HIGH-STIFFNESS HIGH-TOUGHNESS FULLY-DEGRADABLE PBAT/PLA RESIN COMPOSITION AND PREPARATION METHOD THEREFOR

(71) Applicant: Fine Blend Polymer ( Shanghai ) Co., Ltd, Shanghai (CN)

(72) Inventors: Pengwei SHI, Shanghai (CN); Junjie Tang, Shanghai (CN); Pinqiang Guo, Shanghai (CN); Yongpeng Jl, Shanghai (CN); Congshan Zhu, Shanghai (CN); Hao Duan, Shanghai (CN); Guangrun Jin, Shanghai (CN)

(21) Appl. No.: 18/646,999

(22) Filed: Apr. 26, 2024

Related U.S. Application Data
(63) Continuation of application No. PCT/CN2022/079629, filed on Mar. 7, 2022.

(30) Foreign Application Priority Data
Oct. 27, 2021 (CN) 202111255891.1

(51) Int. Cl. C08L 67/02; C08K 3/26; C08K 7/08

(52) U.S. Cl. CPC C08L 67/02; C08K 3/26; C08K 7/08; C08K 2003/265; C08K 2201/003; C08L 2201/06

(57) ABSTRACT

The present invention discloses a high-stiffness high-toughness fully-degradable resin composition. The composition includes the following raw material components in parts by weight: 60-80 parts of PBAT; 10-30 parts of PLA; 5-15 parts of a calcium carbonate whisker; 0.3-0.6 parts of a high molecular weight chain extension compatilizer; 0.01-0.1 parts of a coupling agent; and other processing aids. A preparation method includes: treating a calcium carbonate whisker with a coupling agent, then mixing same with PBAT followed by extrusion and granulation by using a double-screw extruder to obtain a calcium carbonate whisker masterbatch; and then premixing the calcium carbonate whisker masterbatch, PLA, a high molecular weight chain extension compatilizer and an auxiliary agent, followed by melt extrusion and granulation to obtain a high-stiffness high-toughness fully-degradable PBAT/PLA resin composition.

This application is a Continuation application of PCT/CN2022/079629, filed on Mar. 7, 2022, which claims priority to Chinese Patent Application No. 202111255891.1, filed on Oct. 27, 2021, which is incorporated by reference for all purposes as if fully set forth herein.

### TECHNICAL FIELD

This invention belongs to the field of high polymer material modification technology, and specifically relates to a PBAT/PLA (poly(butylene adipate-co-terephthalate)/poly(lactic acid)) resin composition with high stiffness, high toughness and fully degradable and its preparation method.

### BACKGROUND OF INVENTION

PBAT and PLA are currently the two fully biodegradable polymers which have been researched, produced and commercialized the most. They complement each other's advantages by blending and modifying two materials, so that the product material has high strength as well as good toughness, which is one of the current hotspots in the modification of biodegradable materials. Compared with traditional PE films, the films prepared from PBAT/PLA alloys mainly composed of PBAT have low stiffness and poor texture because PBAT materials have lower crystallinity and are soft, giving a cheap feeling of “softness.”

Many patents focus on improving the compatibility and strength of PBAT/PLA composite materials, without paying attention to how to improve the stiffness of the final film product. It is the biggest challenge faced by researchers and technicians in this field to improve the compatibility and toughness of PBAT/PLA composite materials while maintaining the high stiffness of film product.

Patent CN 111378259 A disclosed a small molecule compound containing epoxy groups as a compatibilizer for PBAT/PLA composite material, which facilitated the improvement of mechanical properties of PBAT/PLA composite material, especially maintaining high rigidity and toughness; However, this small molecule compatibilizer had defects such as the difficulty in adding materials, large volume of addition (0.52 parts), and significant impact of residual monomers on the odor of the product.

Patent CN 109504041 A disclosed a TPS/PLA/PBAT blending modified biodegradable resin prepared with a chain extender, which used KLE as the chain extender to enhance the compatibility of the two-phase system; The KLE series of Coal Chemical Institute and the ADR series of BASF company were both epoxy type chain extenders, but their molecular weights were low, both below 10000.

Patent CN105199347 A used Na-montmorillonite to enhance the blending modification of masterbatch to obtain PLA/PBAT composite material with excellent performance. However, montmorillonite had a layered structure, which was difficult to be peeled off, making it difficult for industrialization; In addition, although montmorillonite can improve the strength of composite material, its size in a single direction was still small, and its effect on improving material stiffness was limited.

Patent CN109825048 A used OMMT and EGMA to synergistically improve the strength and toughness of materials. EGMA improved the problem of poor interfacial adhesion between the two phases, and OMMT acted as a physical crosslinking point to enhance material strength. However, OMMT also had a small size in a single direction, and had limited effect on improving material stiffness.

Patent CN 110079065 A and CN 106750253 A mainly focused on improving the compatibility of PLA/PBAT composite material, while the compatilizer in patent CN 110079065 A was 1-10%, with a large amount added and the compatibilizer in patent CN 106750253 A could act as a light stabilizer and antibacterial agent, but the synthesis steps of the compatibilizer were complex, and the environmental friendliness of the raw materials used needed to be verified.

### Technical Problems

It's required to improve the compatibility and toughness of PBAT/PLA composite materials while maintaining the high stiffness of film product. One of the purposes of the present invention is to provide a PBAT/PLA resin composition with high stiffness, high toughness and fully degradable. The second purpose of the present invention is to provide a preparation method of a PBAT/PLA resin composition with high stiffness, high toughness and fully degradable.

### Technical Solution

The present invention provides a PBAT/PLA resin composition with high stiffness, high toughness and fully degradable, comprising PLA, PBAT, calcium carbonate whiskers, high molecular weight chain extension compatibilizer, coupling agent, and additive.

Furthermore, the composition is prepared from raw materials comprising the following components in parts by weight:

| | | |
|---|---|---|
| PBAT | 60-80 | parts |
| PLA | 10-50 | parts |
| calcium carbonate whisker | 5-15 | parts |
| high molecular weight chain extension compatibilizer | 0.3-0.6 | parts |
| coupling agent | 0.01-0.1 | parts |
| additive | 0.3-0.5 | parts |

The length of the calcium carbonate whisker is 10-30 μm with the diameter of 0.5-1.0 μm and the length to diameter ratio ≤20.

The high molecular weight chain extension compatibilizer is a polymer containing epoxy groups, with a weight-average molecular weight Mw of 20000-50000, an epoxy equivalent of 290-310 g/mol, and a glass-transition temperature Tg≤80° C.

The coupling agent described is at least one of γ-aminopropyltriethoxysilane, γ-glycidoxypropyltrimethoxysilan and γ-(methacryloxy) propyl trimethoxyl silane.

As a preferred solution, the coupling agent is γ-glycidoxypropyltrimethoxysilan (KH560).

The weight-average molecular weight Mw of PBAT is 100000-150000, and the weight-average molecular weight Mw of PLA is 80000-120000.

The additives include antioxidants, lubricants, and opening agents.

The present invention also provides a preparation method for a PBAT/PLA resin composition with high stiffness, high toughness and fully degradable, comprising the following steps: S1. Weigh the following components in parts by weight: PBAT: 60-80 parts; PLA: 10-30 parts; Calcium carbonate whiskers: 5-15 parts; High molecular weight chain extension compatibilizer: 0.3-0.6 parts; Coupling agent: 0.01-0.1 parts; Additives 0.3-0.5 parts.

S2. The calcium carbonate whiskers are treated with coupling agents, then mixed with PBAT and melted by a twin-screw extruder to be blended, extruded and pelleted to obtain the calcium carbonate whisker masterbatch.

S3. The calcium carbonate whisker masterbatch prepared in step S2 is pre-mixed, melt, extruded and pelleted with PLA, high molecular weight chain extension compatibilizer, and additives to obtain the PBAT/PLA resin composition with high stiffness, high toughness and fully degradable.

In step S2, the parameters used for the melt extrusion are: feeding section temperature of 80-120° C., plasticization section temperature of 140-160° C., homogenization section temperature of 160-180° C., and screw speed of 300-600 rpm.

In step S3, the parameters used for the melt extrusion are: feeding section temperature of 80-120° C., plasticization section temperature of 160-180° C., homogenization section temperature of 180-210° C., and screw speed of 300-600 rpm.

### Beneficial Effects

Compared with existing technology, the present invention has the following beneficial effects: (1) The use of high molecular weight chain extension compatibilizer: The present invention uses high molecular weight chain extension compatibilizer as the chain extension compatibilizer for PBAT/PLA composite materials. Compared with traditional low molecular weight chain extenders (such as Basf's ADR series and China Coal Chemical Institute's KLE4370, both with molecular weight between 5000-10000), the high molecular weight chain extension compatibilizer used in the present invention has a weight-average molecular weight of 20000-50000. The low molecular weight chain extenders have better tackifying and chain extension effects in single-component polycondensate such as PLA and PET systems. And the high molecular weight chain extension compatibilizers are more suitable for improving the compatibility of alloy systems, such as PBAT/PLA alloys, PLA/PBAT alloys and PBS (PBSA)/PBAT alloys, etc.

(2) The filling of calcium carbonate whisker with high length to diameter ratio: Compared with traditional zero-dimensional material fillers (such as calcium carbonate, silicon dioxide, starch, etc.) and two-dimensional fillers (such as montmorillonite, talc powder, graphene, etc.), calcium carbonate whiskers themselves have extremely high strength and length to diameter ratio, and only a small amount of addition can significantly improve the strength and stiffness of the material. The size of calcium carbonate whiskers is at the micron level, which will not affect the appearance of the final film product. Moreover, they are cheap and easily dispersed in the resin matrix after treatment.

(3) The high stiffness and synergistic toughening effect: The calcium carbonate whiskers and PLA are in the dispersed phase and simultaneously distributed in the PBAT matrix resin, and the dispersed phase PLA plays a reinforcing role in the PBAT resin; and the calcium carbonate whiskers play a role in reinforcing and improving the stiffness of the final film product. The resin composition prepared by this method improves the stiffness of film products without increasing costs, providing a resin composition with high toughness and fully degradable. And the cost is low and it's easy to achieve large-scale production.

### BRIEF DESCRIPTION OF THE DRAWINGS

By reading the detailed description of non-limiting Examples with reference to the following drawings, the other features, object, and advantages of the present invention will become more apparent.

FIG. 1 shows the force-displacement curve of the PBAT/PLA resin composition film with high stiffness, high toughness and fully degradable and the microscopic structural diagram of the filler used, corresponding to the mechanical curves of the resin composition in Example 2 and Control 2, respectively.

FIG. 2 is a diagram of the stability of the pelletizing process in Example 1.

FIG. 3 is a diagram of the instability of the pelletizing process in Control 1.

### EXAMPLES OF THE PRESENT INVENTION

Hereinafter, the present invention will be further described with reference to specific Examples. It should be understood that these Examples are only used to illustrate the present invention and not to limit the scope of the present invention. Furthermore, it should be understood that after reading the content described in the present invention, those skilled in the art may make various changes or modifications to the present invention, and these equivalent forms also fall within the scope of the claims attached to this application.

The PBAT/PLA resin composition with high stiffness, high toughness and fully degradable in Example 1-4 includes the following raw materials in parts by weight:

| | | |
|---|---|---|
| PBAT | 60-80 | parts |
| PLA | 10-30 | parts |
| Calcium carbonate whisker | 5-15 | parts |
| High molecular weight chain extension compatibilizer | 0.3-0.6 | parts |
| Coupling agent | 0.01-0.1 | parts |
| Additive | 0.3-0.5 | parts |

It should be noted that in the following Examples and Controls:
PBAT was placed in an oven at 80° C. and dried for more than 3 hours to remove moisture. The weight-average molecular weight Mw of PBAT was 100000-150000;
PLA was placed in an oven at 65° C. and dried for more than 5 hours to remove moisture. The weight-average molecular weight Mw of PLA was 80000-120000;
High molecular weight chain extension compatibilizer: HPC 3510P; Commercially available;
Low molecular weight chain extender: KLE4370 or ADR 4468, commercially available;
Coupling agent KH560 and additives; Commercially available.

Among the additives, the mass ratio of antioxidants, lubricants, and opening agents was 2:1:1, among which the antioxidant was 168, the lubricant was EBS, and the opening agent is SiO₂. The additives and their applications are conventional methods in this field.

### Example 1-4

Example 1-4 provides a PBAT/PLA resin composition with high stiffness, high toughness and fully degradable, which was prepared according to the components and content in Table 1 respectively.

TABLE 1
Components and component contents
in Example 1-4 (In part by weight)

| | experimental group | | | |
|---|---|---|---|---|
| | Example | Example | Example | Example |
| raw material | 1 (Part) | 2 (Part) | 3(Part) | 4 (Part) |
| PBAT | 65 | 80 | 60 | 65 |
| PLA | 30 | 10 | 25 | 23 |
| coupling agent | 0.01 | 0.1 | 0.06 | 0.06 |
| KH560 | | | | |
| Calcium carbonate | 5 | 10 | 15 | 12 |
| whisker | | | | |
| High molecular | 0.3 | 0.5 | 0.6 | 0.5 |
| weight chain | | | | |
| extender | | | | |
| compatibilizer | | | | |
| HPC3510P | | | | |
| Other additives | 0.5 | 0.4 | 0.3 | 0.4 |

The preparation method of Example 1-2 is as follows:
S1. The raw materials were weighed according to Table 1;

S2. The calcium carbonate whiskers were treated with coupling agents, then mixed with PBAT and melted by a twin-screw extruder to be blended, extruded and pelleted to obtain the calcium carbonate whisker masterbatch; the parameters used for the melt extrusion are: feeding section temperature of 80° C., plasticization section temperature of 140° C., homogenization section temperature of 160° C., and screw speed of 300 rpm.

S3. The calcium carbonate whisker masterbatch prepared in step S2 was pre-mixed, melt, extruded and pelleted with PLA, high molecular weight chain extension compatibilizer, and additives to obtain the PBAT/PLA resin composition with high stiffness, high toughness and fully degradable; the parameters used for the melt extrusion are: feeding section temperature of 80° C., plasticization section temperature of 160° C., homogenization section temperature of 180° C., and screw speed of 300 rpm.

The preparation method of Example 3-4 is as follows:
S1. The raw materials were weighed according to Table 1;
S2. The calcium carbonate whiskers were treated with coupling agents, then mixed with PBAT and melted by a twin-screw extruder to be blended, extruded and pelleted to obtain the calcium carbonate whisker masterbatch; the parameters used for the melt extrusion are: feeding section temperature of 120° C., plasticization section temperature of 160° C., homogenization section temperature of 180° C., and screw speed of 600 rpm.
S3. The calcium carbonate whisker masterbatch prepared in step S2 was pre-mixed, melt, extruded and pelleted with PLA, high molecular weight chain extension compatibilizer, and additives to obtain the PBAT/PLA resin composition with high stiffness, high toughness and fully degradable; the parameters used for the melt extrusion are: feeding section temperature of 120° C., plasticization section temperature of 160° C., homogenization section temperature of 180° C., and screw speed of 600 rpm.

### Control 1:

The component and preparation method of the raw materials in this Control are basically the same as that in Example 1, except that the high molecular weight chain extension compatibilizer was replaced with the low molecular weight chain extender KL-E4370.

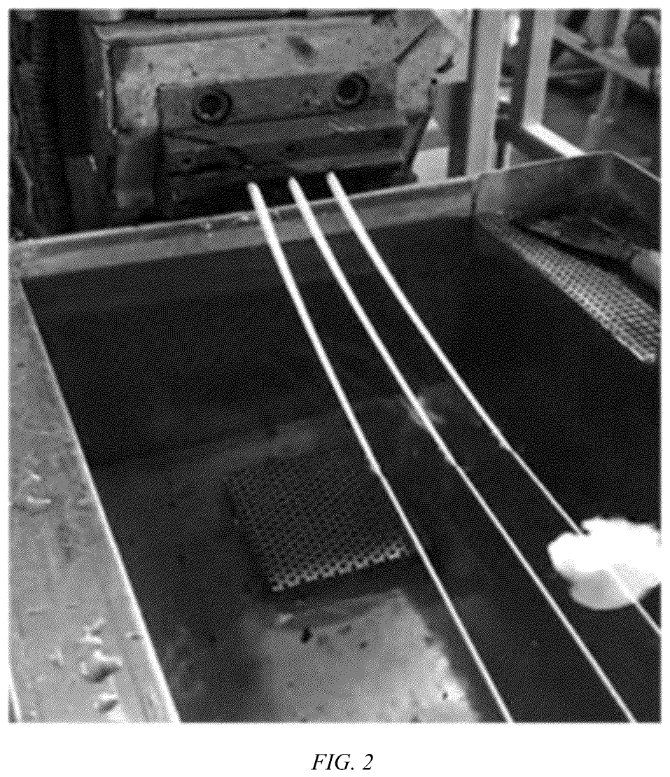

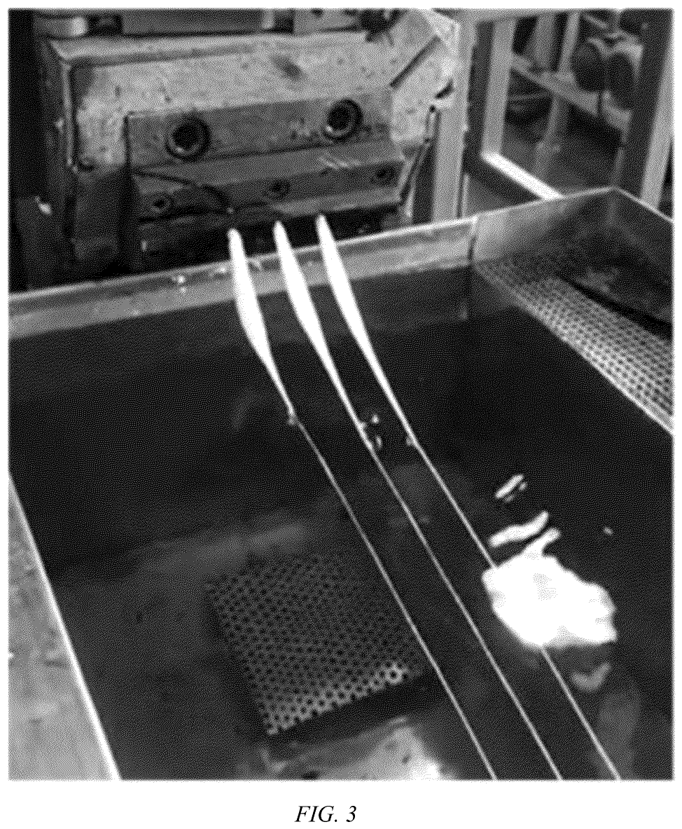

FIG. 2 shows the pelletizing process of Example 1 of the present invention; FIG. 3 shows the pelletizing process for Control 1, and the results show that the high molecular weight chain extension compatibilizer has an improved effect on the processability and compatibility of the PBAT/PLA resin composition with high stiffness, high toughness and fully degradable.

### Control 2:

The component and preparation method of the raw materials in this Control are basically the same as that in Example 1, except that the high molecular weight chain extension compatibilizer was replaced with the low molecular weight chain extender ADR 4468.

### Control 3:

The Control 3 is set to verify the effect of universal calcium carbonate and calcium carbonate whiskers on improving the toughness and stiffness of the PBAT/PLA resin composition with high stiffness, high toughness and fully degradable.

The component and preparation method of the raw materials in this Control are basically the same as that in Example 2, except that the calcium carbonate whiskers were replaced with universal calcium carbonate powder.

### Control 4:

The Control 4 is used to compare with Example 3 and verify the effect of coupling agent KH560 on improving the strength of the PBAT/PLA resin composition with high stiffness, high toughness and fully degradable.

The component and preparation method of the raw materials in this Control are basically the same as that in Example 3, except that no coupling agent was added.

### Control 5:

This Control is to compare and verify the effect of segmented pelletizing process on the stiffness and toughness of the PBAT/PLA resin composition with high toughness and fully degradable. The preparation method of the PBAT/PLA resin composition with high stiffness, high toughness and fully degradable described in the Control 5 includes the following steps: PBAT, PLA, calcium carbonate whiskers treated with coupling agent, high molecular weight chain extension compatibilizer, and additives were pre-mixed, melt, extruded and pelleted to obtain the PBAT/PLA resin composition; The process parameters used for melt blending were identical to those of step S3 in Example 4.

### Control 6:

The component and preparation method of the raw materials in this Control are basically the same as that in Example 4, except that PLA was not added as a reinforcing resin.

### Performance Test:

The samples obtained from Example 1-4 and Control 1-6 were used for performance test: the tensile strength and elongation were tested according to ISO 527 standard, with a tensile rate of 50 mm/min; The stiffness test was conducted using a Taber stiffness tester, and before the test, the composition was made into a film with a thickness of 30 μm. The relevant test data is shown in Table 2 below.

TABLE 2
Physical property test data of Example 1-4 and Control 1-6

| | Test parameter | | | |
|---|---|---|---|---|
| | | Tensile | | |
| | Production | strength | Elongation | Stiffness of |
| Test group | phenomenon | (MPa) | were (%) | the film (mN · m) |
| Example 1 | traction and | 24.6 | 678 | 3.6 |
| Example 2 | pelletizing | 23.9 | >800 | 3.7 |
| | process stable | | | |
| Example 3 | | 29.1 | 607 | 4.8 |
| Example 4 | | 27.7 | 582 | 4.5 |
| Control 1 | traction and | 22.8 | 576 | 3.4 |
| Control 2 | pelletizing had | 22.8 | 588 | 3.2 |
| | broken bars | | | |
| Control 3 | traction and | 18.6 | >800 | 2.4 |
| Control 4 | pelletizing | 24.7 | 574 | 4.6 |
| Control 5 | process stable | 25.8 | 432 | 4.2 |
| Control 6 | | 17.2 | >800 | 2.9 |

According to the results of Example 1-4 in Table 2, the resin compositions prepared with the formula and process of the present invention have excellent toughness and stiffness. Because the calcium carbonate whiskers and PLA used in the present invention were in the dispersed phase and simultaneously distributed in the PBAT matrix resin, and the dispersed phase PLA played a reinforcing role in the PBAT resin, and the calcium carbonate whiskers played a role in reinforcing and improving the stiffness of the final film product. The two reinforcing materials exhibited excellent synergy effect in phase or morphology.

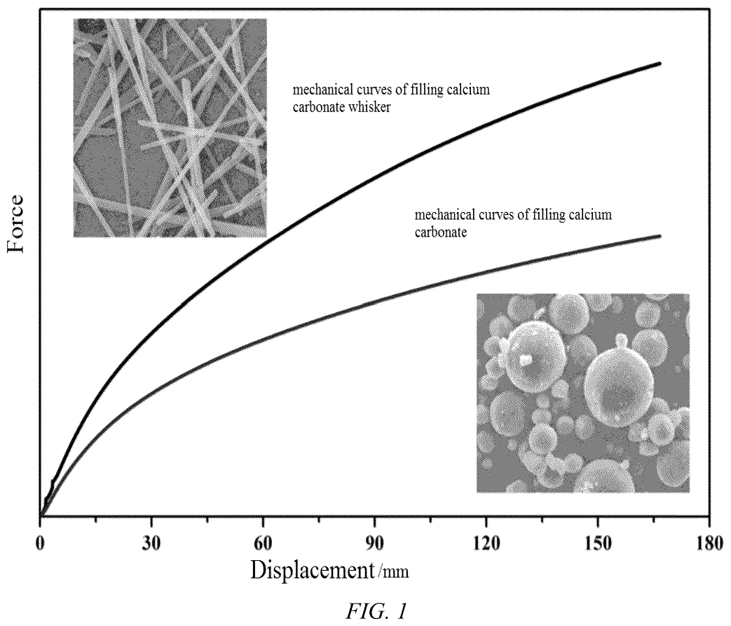

FIG. 1 shows the force displacement curves of resin composition films in Example 2 of the present invention and Control 3; It can be seen that compared with traditional calcium carbonate fillers, the calcium carbonate whiskers themselves had extremely high strength and length to diameter ratio, which had a better effect on improving the strength and stiffness of the material, while maintaining a higher elongation. This is the key to the high stiffness and high toughness of the composition.

FIG. 2 shows the resin composition traction and pelletizing process using a high molecular weight chain extension compatibilizer in Example 1, and FIG. 3 shows the resin composition traction and pelletizing process using low molecular weight chain extenders KL-E4370 and ADR4468 as chain extenders in Control 1 and Control 2; From the results of Control 1 and Control 2, it can be seen that high molecular weight chain extension compatibilizers were more suitable for improving the compatibility of PBAT/PLA alloys, making the traction and pelletizing process more stable.

From the results of Control 4 and Example 3, it can be seen that the calcium carbonate whiskers treated with coupling agents had higher strength and elongation at break. From the results of Control 5 and Example 4, it can be seen that the segmented pelletizing process could achieve a synergistic reinforcing and toughening effect of PLA and calcium carbonate whiskers in terms of phase or morphology, and the dispersed phase PLA enhanced PBAT resin, while the calcium carbonate whiskers reinforced and improved the stiffness of the final film product. From the results of Control 6 and Example 4, it can be seen that PLA could achieve the effect of reinforcing PBAT and improving stiffness, while the reinforcing effect of pure calcium carbonate whiskers was poor.

The specific Examples of the present invention have been described above. It should be understood that the present invention is not limited to the specific Examples mentioned above. Those skilled in the art may make various variations or modifications within the scope of the claims, which does not affect the substantive content of the present invention.

1. A high stiffness, high toughness and fully degradable PBAT/PLA (poly(butylene adipate-co-terephthalate)/poly(lactic acid)) resin composition, comprising a PLA, a PBAT, a calcium carbonate whisker, a high molecular weight chain extension compatibilizer, a coupling agent, and an additive.

2. The high stiffness, high toughness and fully degradable PBAT/PLA resin composition according to claim 1, wherein the composition is prepared from raw materials comprising the following components in parts by weight:
the PBAT: 60-80 parts,
the PLA: 10-50 parts,
the calcium carbonate whisker: 5-15 parts,
the high molecular weight chain extension compatibilizer: 0.3-0.6 parts,
the coupling agent: 0.01-0.1 parts, and
the additive: 0.3-0.5 parts.

3. The high stiffness, high toughness and fully degradable PBAT/PLA resin composition according to claim 1, wherein a length of the calcium carbonate whisker is 10-30 μm with a diameter of 0.5-1.0 μm.

4. The high stiffness, high toughness and fully degradable PBAT/PLA resin composition according to claim 1, wherein the high molecular weight chain extension compatibilizer is a polymer containing epoxy groups, with a weight-average molecular weight Mw of 20,000-50,000, an epoxy equivalent of 290-310 g/mol, and a glass-transition temperature Tg≤80° C.

5. The high stiffness, high toughness and fully degradable PBAT/PLA resin composition according to claim 1, wherein the coupling agent is at least one of γ-aminopropyltriethoxysilane, γ-glycidoxypropyltrimethoxysilan and γ-(methacryloxy) propyl trimethoxyl silane.

6. The high stiffness, high toughness and fully degradable PBAT/PLA resin composition according to claim 1, wherein a weight-average molecular weight Mw of the PBAT is 100,000-150,000, and a weight-average molecular weight Mw of the PLA is 80,000-120,000.

7. The high stiffness, high toughness and fully degradable PBAT/PLA resin composition according to claim 1, wherein the additive includes an antioxidant, a lubricant, and an opening agent.

8. A method for preparing a high stiffness, high toughness and fully degradable PBAT/PLA resin composition, comprising the following steps:
S1: weighing the following components in parts by weight: a PBAT (poly(butylene adipate-co-terephthalate): 60-80 parts; a PLA (poly(lactic acid)): 10-30 parts; a calcium carbonate whisker: 5-15 parts; a high molecular weight chain extension compatibilizer: 0.3-0.6 parts; a coupling agent: 0.01-0.1 parts; an additive: 0.3-0.5 parts;
S2: treating the calcium carbonate whisker with the coupling agent, then mixing with the PBAT and melting by a twin-screw extruder to be blended, extruded and pelleted to obtain a calcium carbonate whisker masterbatch;
S3: pre-mixing, melting, extruding, and pelleting the calcium carbonate whisker masterbatch prepared in step S2 with the PLA, the high molecular weight chain extension compatibilizer, and the additive to obtain the high stiffness, high toughness and fully degradable PBAT/PLA resin composition.

9. The method according to claim 8, wherein in step S2, parameters used for melting comprise: a feeding section temperature of 80-120° C., a plasticization section temperature of 140-160° C., a homogenization section temperature of 160-180° C., and a screw speed of 300-600 rpm.

10. The method according to claim 8, wherein in step S3, parameters used for melting comprise: a feeding section temperature of 80-120° C., a plasticization section temperature of 160-180° C., a homogenization section temperature of 180-210° C., and a screw speed of 300-600 rpm.
